(19) United States
(12) Patent Application Publication
(10) Pub. No.: US 2004/0128880 A1
(43) Pub. Date: Jul. 8, 2004

(54) Display device for shutter

(76) Inventor: Seiji Abe, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/738,094

(22) Filed: Dec. 18, 2003

(30) Foreign Application Priority Data
Dec. 20, 2002 (JP) 2002-370884
Apr. 24, 2003 (JP) 2003-120282
Sep. 16, 2003 (JP) 2003-322718

(51) Int. Cl. G09F 11/18

(52) U.S. Cl. 40/514

(57) ABSTRACT

A display device for a vertically movable rolling shutter with the provision of a rolling/unrolling roller 4 is provided, which permits provision of various advertisement and decoration effect excellent in display character to an existing character without need of any elaborate installation work but in a very simple work, and also permits coping with contamination damage to the shutter surface.

A display device for a shutter is provided, which comprises a flexible display sheet 2 having the upper end secured to the upper end part of the shutter and rolled together with the shutter on the rolling/unrolling roller 4 in the raised state of the shutter, and a pulling member 7 provided on the lower end part of the shutter for holding the having the display sheet in close contact with the shutter surface by biasing the lower end part of the display sheet for pulling the same downward.

### BACKGROUND OF THE INVENTION

1. Field of the Invention

This invention relates to a readily mountable display device for a shutter, which is contemplated from the consideration of a front part of a shutter, which is installed for opening and closing in a building of a shop or the like and capable of being readily noted by passersby in its lowered state, and permits provision of various advertisements and decorations as well as the intrinsic shutter function.

2. Prior Art

Heretofore, shutter decorations are provided by drawing a display subject as decoration in ink or the like on the shutter surface. However, since a shutter is usually produced by combining a plurality of elongate slats, a display subject which is drawn in paint on such a shutter is broken apart at the inter-slat junctures, thus spoiling its aesthetic sense as decoration. Accordingly, a display device for a shutter has been devised, which is obtained by locating a sheet on the surface of a usual shutter and providing a decoration on this sheet. This display device for a shutter has a structure that a display sheet rolling/unrolling unit is disposed on the front top of a shutter rolling/unrolling unit, that the lower end of a display sheet constituted by a magnet sheet with a display subject formed thereon is secured to the lower end of the shutter, and that as the shutter is lowered the display sheet is magnetically attached to and paid off together with the shutter. This prior art display device for a shutter can be installed on an existing shutter, and permits provision of various advertisements and decorations on the shutter surface (see Japanese Patent Laid-Open No. 1-178694, for instance).

However, the above prior art display device for a shutter requires installation of an exclusive display sheet rolling/unrolling unit near the shutter rolling/unrolling unit, and is therefore considerably elaborate. The installation therefore inevitably requires a great deal of labor, a complicated installation work and a great amount of work expenditures. Also, the replacement of the display sheet is not so ready, but its operation requires considerable man-hours. Furthermore, there is recently an undesired trend that many graffiti contaminations in spray paint are produced on the shutter. It is difficult to remove such contaminations from the shutters, and a measure for solving this problem has been demanded.

### SUMMARY OF THE INVENTION

The invention has an object of providing a display device for a shutter, which permits providing various advertisements and decorations having excellent display characters to an existing shutter without need of elaborate installation work by a very simple work and also permits coping with contaminations of the shutter surface.

### BRIEF DESCRIPTION OF THE DRAWINGS

FIG. 1 is a perspective view showing a first embodiment of the display device for a shutter according to the invention;

FIG. 2 is a front view showing the first embodiment of the display device for a shutter according to the invention;

FIG. 3 is a side sectional view showing the first embodiment of the display device for a shutter according to the invention;

FIG. 4 is a plan sectional view showing the display device for a shutter according to the invention;

FIG. 5 is a back view showing the display device for a shutter according to the invention;

FIG. 6 is an exploded fragmentary view showing a display sheet in the display device for a shutter according to the invention;

FIG. 7 is a back view showing a different example of display sheet in the display device for a shutter according to the invention;

FIG. 8 is an exploded perspective view showing the display sheet in the display device for a shutter according to the invention;

FIG. 9 is a side sectional view showing the display device for a shutter according to the invention in use;

FIG. 10 is a front view showing the first embodiment of the display device for a shutter according to the invention in the state that the shutter has been raised;

FIG. 11 is a view for describing a pulling unit in the display device for a shutter according to the Invention;

FIG. 12 is a perspective view showing a second embodiment of the display device for a shutter according to the invention;

FIG. 13 is a perspective view showing a third embodiment of the display device for a shutter according to the invention;

FIG. 14 is a front view showing the third embodiment of the display device for a shutter according to the invention:

FIG. 15 is a front view showing the third embodiment of the display device for a shutter according to the invention in a state that the shutter has been raised;

FIG. 16 is a perspective view showing a stopper in a fourth embodiment of the display device for a shutter according to the invention;

FIG. 17 is a fragmentary sectional view showing the fourth embodiment of the display device for a shutter according to the invention;

FIG. 18 is a fragmentary sectional view showing the FIG. 17 display device in a state that a sheet has been moved;

FIG. 19 is a view for describing the mounting of the stopper in the fourth embodiment of the display device for a shutter according to the invention;

FIG. 20 is a side sectional view showing a fifth embodiment of the display device for a shutter according to the invention in a state that the shutter has been lowered;

FIG. 21 is a side sectional view showing the fifth embodiment of the display device for a shutter according to the invention in a state that the shutter is being raised;

FIG. 22 is a side sectional view showing the fifth embodiment of the display device for a shutter according to the invention in a state that the shutter has been raised;

FIG. 23 is a sectional view taken along line A-A in FIG. 20;

FIG. 24 is a side sectional view showing a prior art display device for shutter in a state that the shutter has been raised;

FIG. 25 is a perspective view showing a sixth embodiment of the display device for a shutter according to the invention; and

FIG. 26 is a perspective view showing the sixth embodiment of the display device for a shutter according to the invention.

### DETAILED DESCRIPTION OF THE PREFERRED EMBODIMENTS

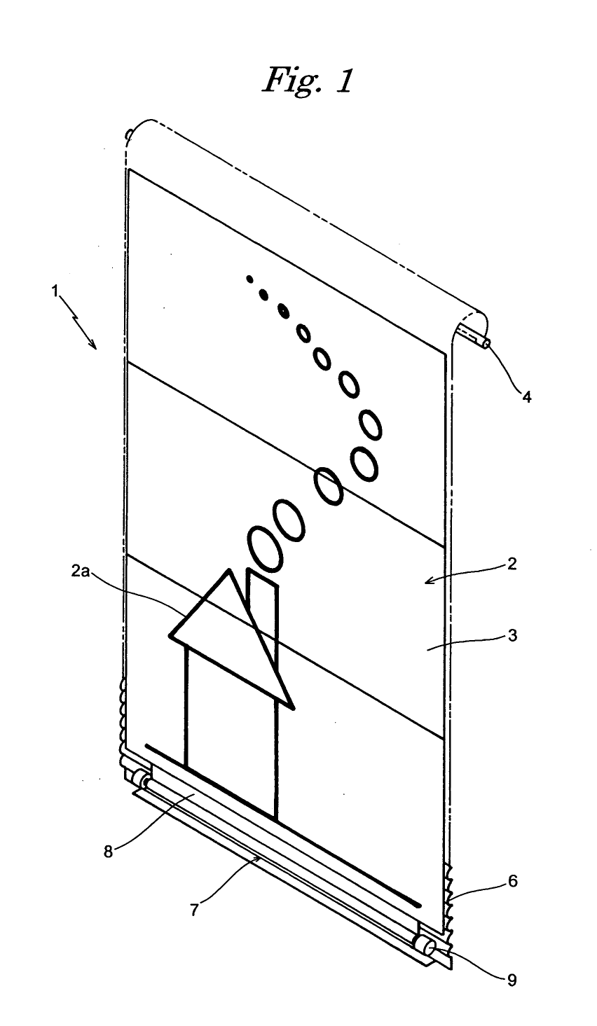

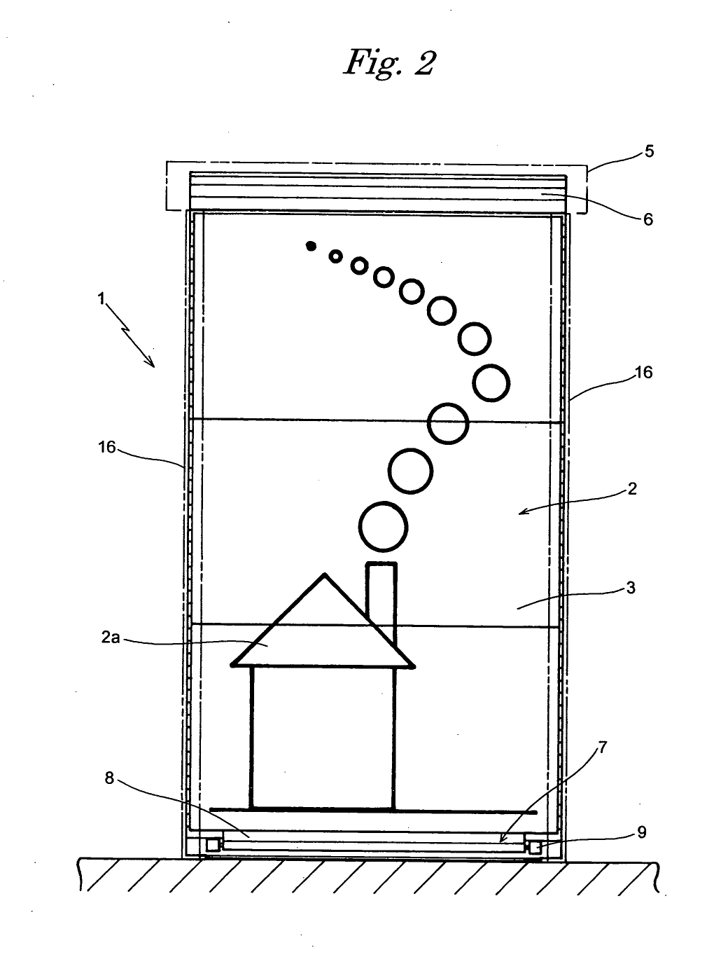

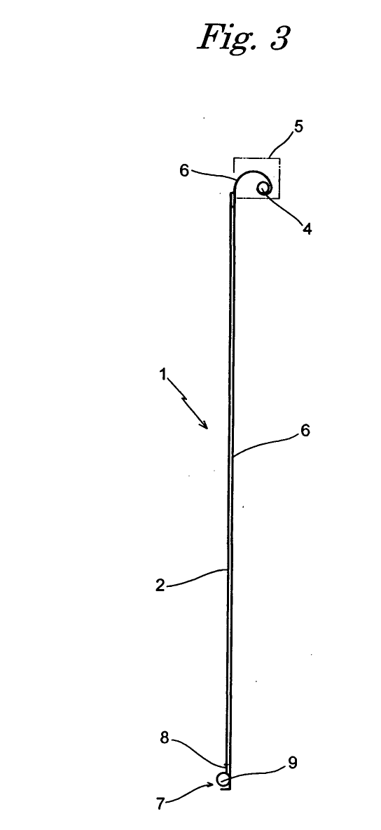

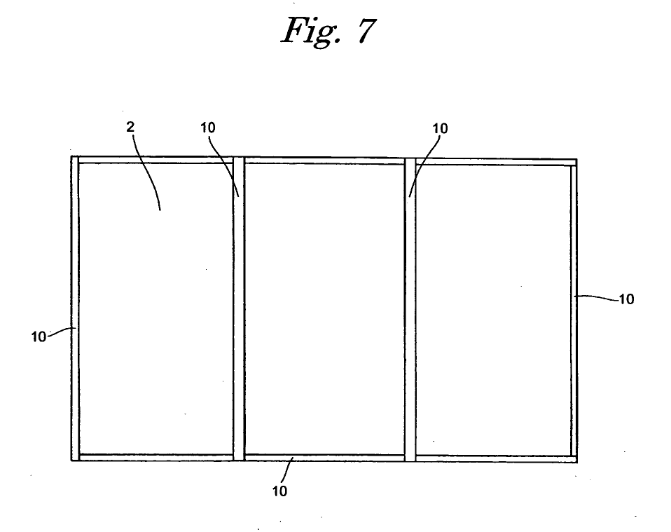

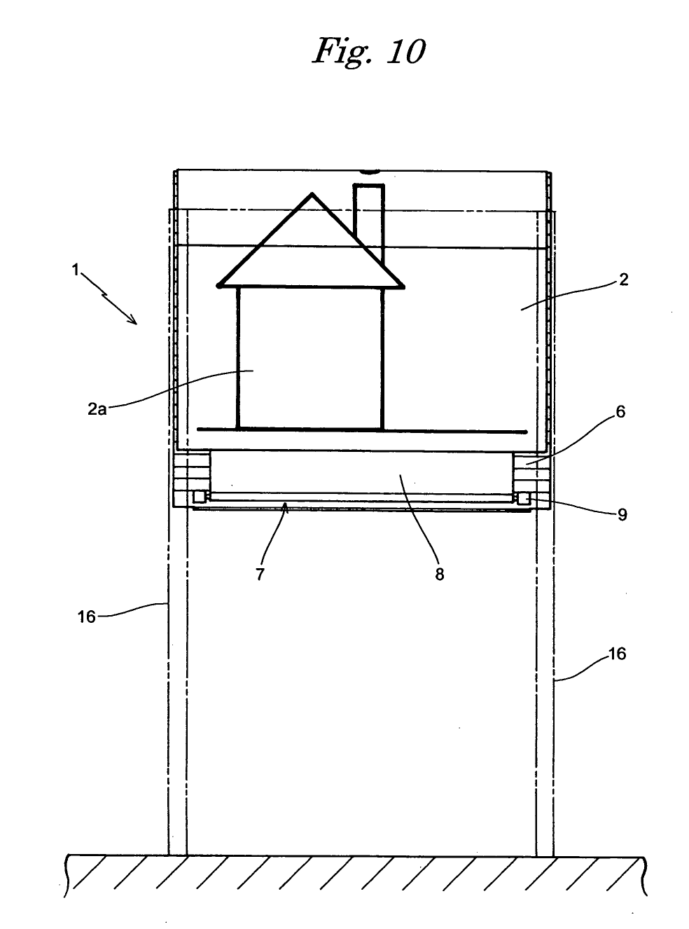

FIGS. 1 to 10 show a first embodiment of the display device 1 for shutter according to the invention. The display device 1 for a shutter comprises a display sheet 2. The display sheet 2 is constituted by a flexible synthetic resin sheet such as tarpaulin sheet or PVC (polyvinyl chloride) sheet. For the advertisement or decoration purpose, a display subject 2a of characters, drawings, etc. is formed on the surface of the synthetic resin sheet. Further, as a measure against production of graffiti or like contaminations on the surface, that is, in order that graffiti produced in color spray paint or the like can be readily wiped off the surface with such solvent as thinner or alcohol or with a detergent, as shown in FIG. 7, the surface is provided with an anti-contamination treatment 3 of laminating transparent polyester film or PVC film on it or coating a fluorine resin or the like on it. The display sheet 2 has its upper end secured with double-side bond or bond tape to an upper part of a take-up type shutter 6 of steel (in the lowered state of the shutter), which is vertically movable and capable of being rolled on a rolling/unrolling roller 4 provided in an upper part to be accommodated in a shutter box 5 (shown in FIGS. 2 and 3) as an accommodation zone formed in an upper surface part. In the lowered state of the shutter 6, the display sheet 2 is held attached to the entire surface of the shutter 6. When the shutter 6 is rolled on the rolling/unrolling roller 4, the display sheet 2 is also rolled together with the shutter 6 on the rolling/unrolling roller 4. In the lowered state of the shutter 6, the display sheet 2 is stretched without warping on the surface of the shutter 6. In order that when raising the shutter 6 the display sheet 2 be rolled in good order together with the shutter 6 while holding its location on the shutter surface, the lower end of the display sheet 2 is biased for pulling downward by a pulling unit 7 secured to the lower end of the shutter 6. The pulling unit 7 includes a rotor 9 provided with a spring for biasing a pull sheet 8, which is tied to the lower end of the display sheet 2, in the direction of taking up the pull sheet 8. The pulling unit 7 is by no means limitative as a means for biasing the display sheet 2 for pulling the same downward, and it is also possible to use a spring, a rubber member, etc. having the function of extension and contraction.

The above construction of the display device for a shutter according to the invention is provided from the consideration of the construction of rolling shutters. The rolling shutter is constructed by inter-coupling a plurality of elongate slats to one another in the vertical direction. Between adjacent inter-coupled slats, a gap called “play” or “rattle” is provided so that the shutter can be elongated and contracted to a certain extent in the vertical direction. Thus, when rolling the shutter, the outer periphery part of the play between the adjacent inter-coupled slats is elongated while the inner periphery part is contracted, so that the shutter can be rolled to a round form. In the case of making the display sheet and the shutter having the above structure to be integral by bonding the display sheet to the entire surface of the shutter or by securing the upper and lower ends of the display sheet to the shutter, the plays between adjacent inter-coupled slats are fixed and can not be elongated or contracted. Such a shutter cannot be rolled. This status may be avoided by securing only the upper end of the display sheet to the shutter and not securing the lower end. In this case, however, the display sheet is not stretched over the shutter surface, resulting in tilting, twisting or wrinkling of the display sheet as the shutter is raised and lowered. Therefore, it is impossible to obtain display in good order.

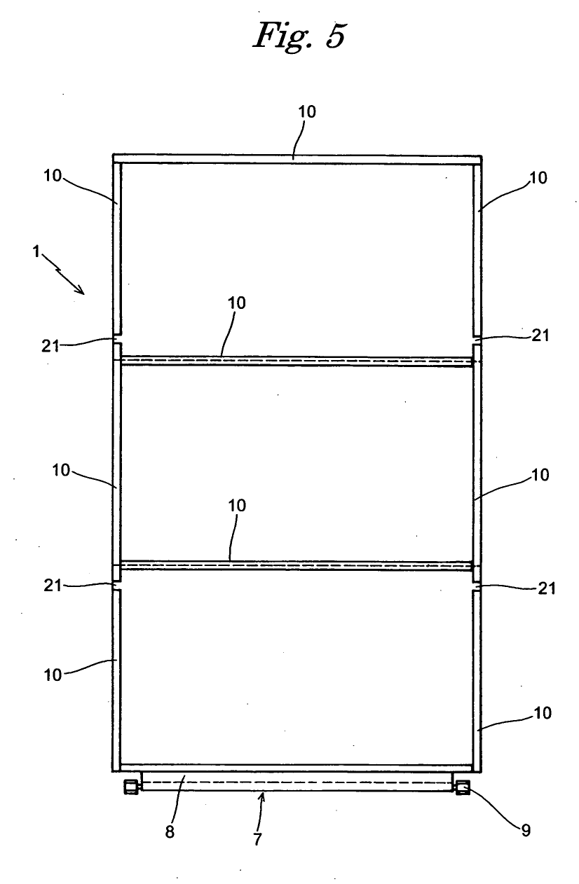

FIG. 5 shows the back side of the display sheet 2. As shown, the display sheet 2 is formed to a single shutter size by bonding three transversally elongate element sheets to one another in the vertical direction. The three elongate element sheets are bonded to one another such that the borderline of the bond is directed downward, that is, the lower, middle and upper sheets are found to be on the front side of one another in the mentioned order (when viewed from the front side). By bonding together the element sheets in this way, the borderlines of the bonds are not noticeable, and the borderline parts are free from rainwater intrusion or contaminant collection.

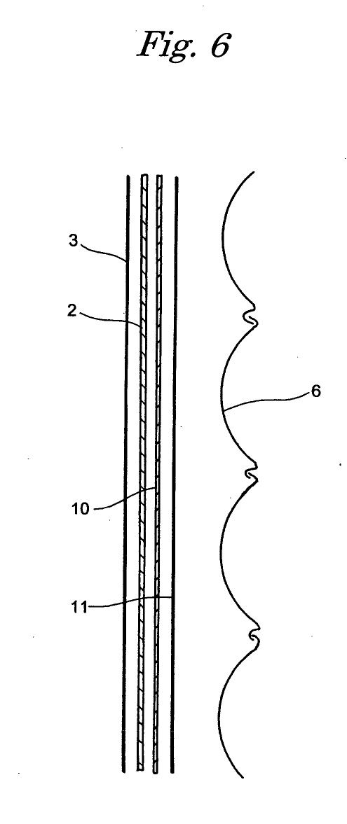

In a different aspect, the display sheet 2 is thin, lacks firmness (i.e., rigidity) and tends to wrinkle, cause shutter surface irregularities or be folded from the end. To provide firmness to the display sheet 2 and have the display sheet 2 held stretched perfectly over the entire surface, as shown in FIG. 5, the display sheet 2 is reinforced by bonding strip-like reinforcement members 10 of softly magnetic stainless steel or hard plastic material with a thickness of about 0.1 millimeter to the four edges of the overall display sheet 2 and bonded parts of the three element sheets. Also, in order that the display sheet 2 can readily slip over the shutter 6 when rolling and unrolling the display sheet 2 together with the shutter 6 with respect to the rolling/unrolling roller 4, as shown in FIG. 6, the display sheet 2 inclusive of the reinforcement members 10 is provided on the back side with a low friction means 11 obtained by applying fluoropolymer sheet such as PTFE (polytetrafluoroethylene) or coating fluoropolymer.

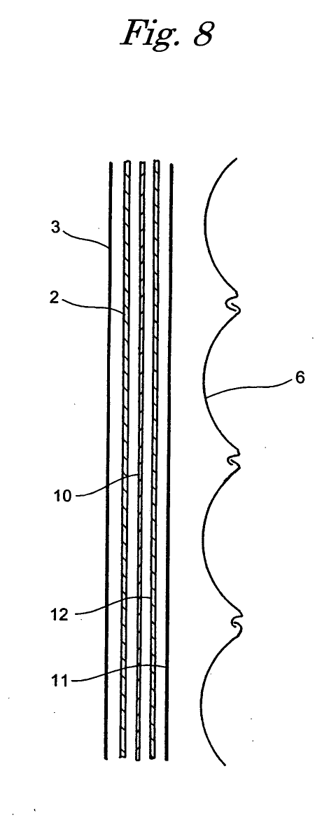

In the case of installing the display device 1 for a shutter according to the invention on a large-size motor-driven shutter, which has a large number of wide slats and has less flat parts, an intermediate part of the display sheet 2 located on the shutter surface tends to be separated from the shutter surface. To prevent such separation, as shown in FIG. 7, two vertical reinforcement members 10, for instance, are provided on the display sheet 2 at intermediate positions thereof and, as shown in FIG. 8, a strip-like magnet sheet 12 is applied to the shutter 6 for magnetizing the same. In order to make the magnet sheet 12 slippery while being magnetically attached to the shutter 6, the low friction means 11 is provided on the surface of the shutter 6 on the side of the reinforcement members 10 and the magnet sheet 12. (Of course, it is also possible to provide the low friction means 11 on the back side of the display sheet 2 without the magnet sheet 12 applied thereto.) The magnet sheet 12 may be applied not only to the parts of the reinforcement members 10 but to the entire back surface of the display sheet 2 in dependence on the status of the display sheet 2 and the shutter 6. The magnet sheet 12 may be what is obtainable by forming a synthetic resin material containing magnetic particles to a sheet-like form with a thickness of about 0.1 to 0.5 mm and multiple poles magnetizing the surface on the front shutter surface side to alternate N and S poles at a pitch of several mm.

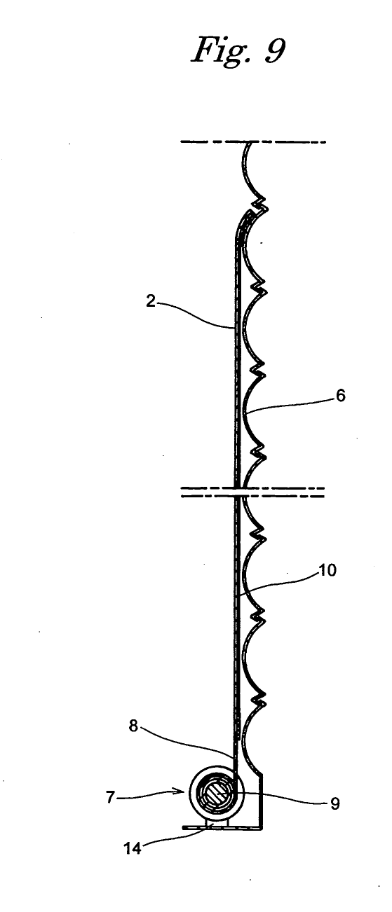

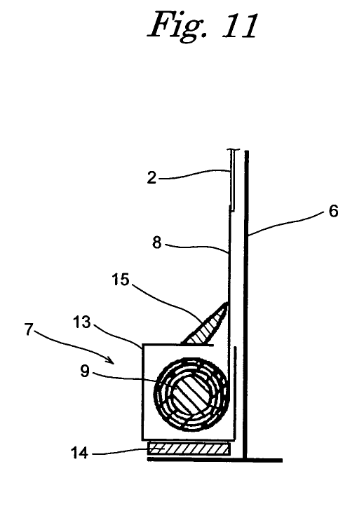

As shown in FIGS. 1 to 5 and 9, the pulling unit 7 noted above is disposed at the lower end of the display sheet 2. In the pulling unit 7, a flexible pull sheet 8 constituted by a tarpaulin sheet or a PVC sheet is biased by a rotor 9 in the rolling direction (i.e., clockwise direction in FIG. 9, and its upper end is tied to the lower end of the display sheet 2. Thus, the display sheet 2 is held stretched normally downward substantially over the entire width of it without any wrinkling. The structure of the pulling unit 7 is like a rolling mechanism used for roll curtains and roll screens, and is capable of being rotated in both directions while internally holding a spring for biasing the rotor 9 in one direction at all times. FIG. 11 shows details of the structure of the pulling unit 7. The pulling unit 7 includes a box member 13, which covers the whole rotor 9 with the pull sheet 8 rolled thereon and unrolled therefrom except for a part with pull sheet 8 passed therethrough, and a magnet member 14, which is secured to the bottom of the box member 13 and constituted by a rare earth magnet or the like having providing powerful magnetic attracting force to be magnetically attached to and de-attached from the shutter 6. This magnet member 14 be used conveniently in that the pulling unit 7 can be installed without need of forming a hole in the existing shutter 6 or causing any damage thereto and also that it can be readily detached for position adjustment of the display sheet 2. The pulling unit 7 further has a rainwater intrusion prevention member 15 having flexibility such as rubber, which is provided at the opening of the box member 13 as passed through by the pull sheet 8 such that its free end is in contact with the surface of the display sheet 2 at all times, thus preventing intrusion of rainwater or the like into the box member 13.

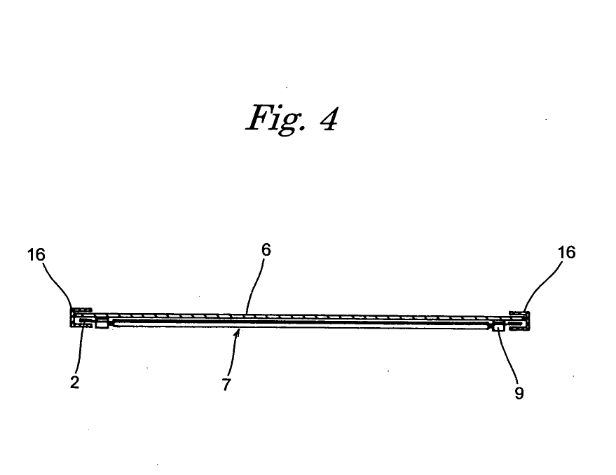

A method of mounting the display device 1 for a shutter 6 according to the invention will now be described. As shown in FIGS. 1 and 2, the shutter 6 as the subject with the display sheet 2 to be installed thereon is lowered and the upper end of the display sheet 2 is reliably secured to as upper end part as possible of the exposed shutter surface by using double-side bond or bond sheet. Then, the magnet member 14 of the pulling unit 7 is magnetically attached and secured to the lower end of the shutter 6. And as shown in FIGS. 2 and 4, both the vertical edges of the display sheet 2 are disposed in a shutter guide 16, which guides both the edges of the shutter 6 by causing sight transversal warping of the display sheet 2. In this way, the display sheet 2 is prevented against being flapped and trailing. The installation work is thus completed.

The operation of the display device 1 for a shutter having the above construction according to the invention will now be described. When the shutter 6 shown in FIGS. 1 and 2 is raised from the lowered state by rotating the rolling/unrolling roller 4 in the rolling direction in the case of the motor-driven type or rotating the rolling/unrolling roller 4 by raising the shutter 6 in the case of the manual drive type, the display sheet 2 is gradually rolled together with the shutter 6 on the rolling/unrolling roller 4. In this embodiment, the shutter 6 is of inward rolling type, and the display sheet 2 is wound on the outer periphery of the roll of the shutter 6. This means that the rolling diameter is greater than the roll diameter in the case of the sole shutter 6 to an extent corresponding to the thickness of the display sheet 2. The display sheet 2 is thus rolled at a speed higher than the rolling speed of the shutter 6. Thus, as shown in FIG. 7, as the shutter 6 is rolled, the display sheet 2 is shifted up relative to the shutter 6, and the pull sheet 8 is gradually unrolled from the pulling unit 7. In the fully raised state of the shutter 6, the up-shift of the display sheet 2 is about 15 cm. However, the pull sheet 8 which is rolled by about 15 cm with the up-shift of the display sheet 2, is finally accommodated in the shutter box 5, and can not be externally noted.

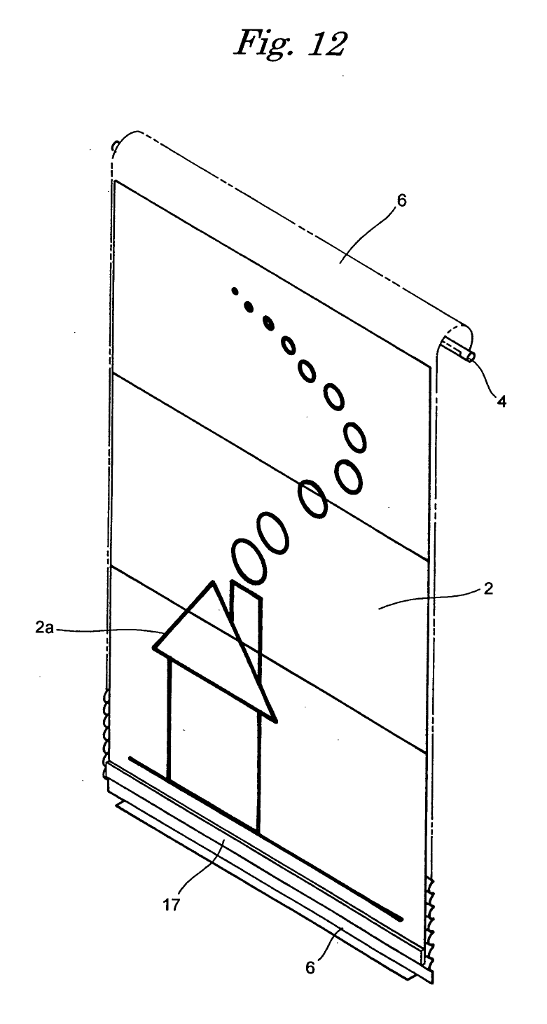

FIG. 2 shows a second embodiment of the display device 1 for a shutter according to the invention. In this embodiment, a pull member for pulling the display sheet 2 downward to hold the same in close contact with the shutter surface, is a weight member 17, which is formed from a metal plate with a thickness of several millimeters and a width of several centimeters and disposed on the lower end part of the display sheet 2. The weight member 17 is not secured to the shutter 6, but is mounted on the display sheet 2 to pull down the same by its own weight at all times. The display sheet 2 thus can be held in orderly close contact with the shutter surface when rolling and unrolling the shutter 6. In the case of FIG. 12, the weight member 17 is disposed on the surface of the display sheet 2 for the sake of the brevity of illustration, but it may be disposed on the back surface as well in view of the aesthetic consideration. The opposite ends of the weight member 17 are located in the shutter guide 16 to have the display sheet 2 in close contact together with the weight member 17 on the shutter surface.

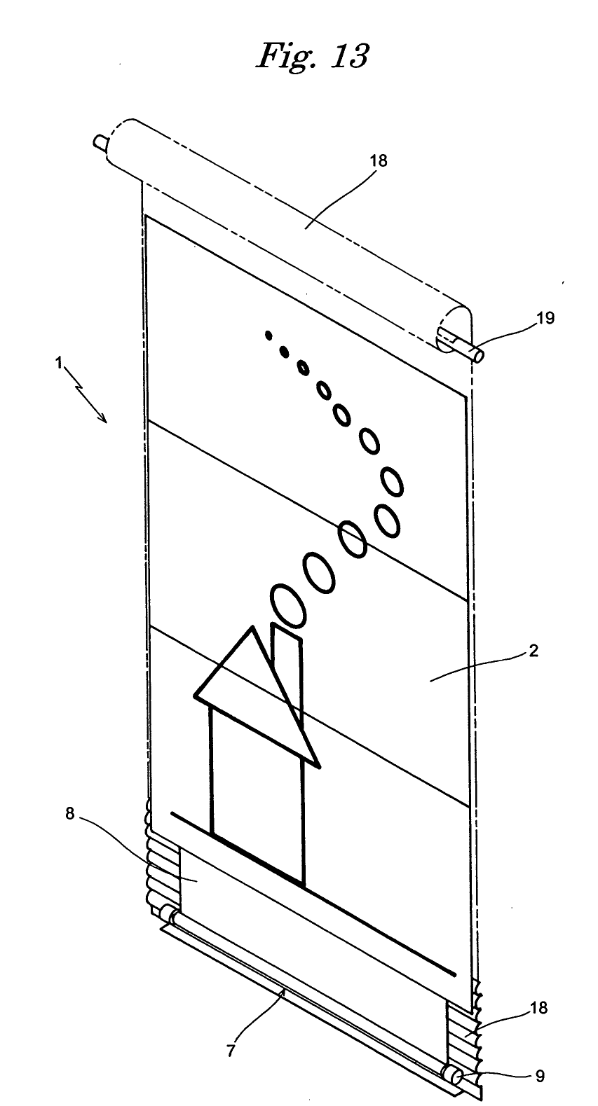

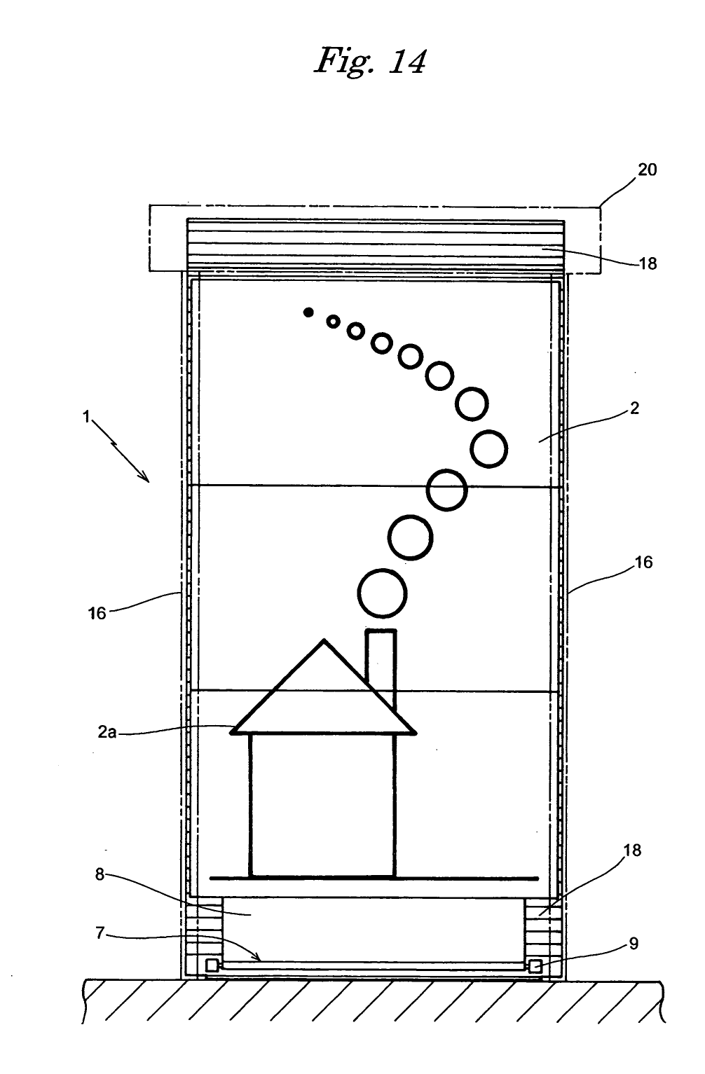

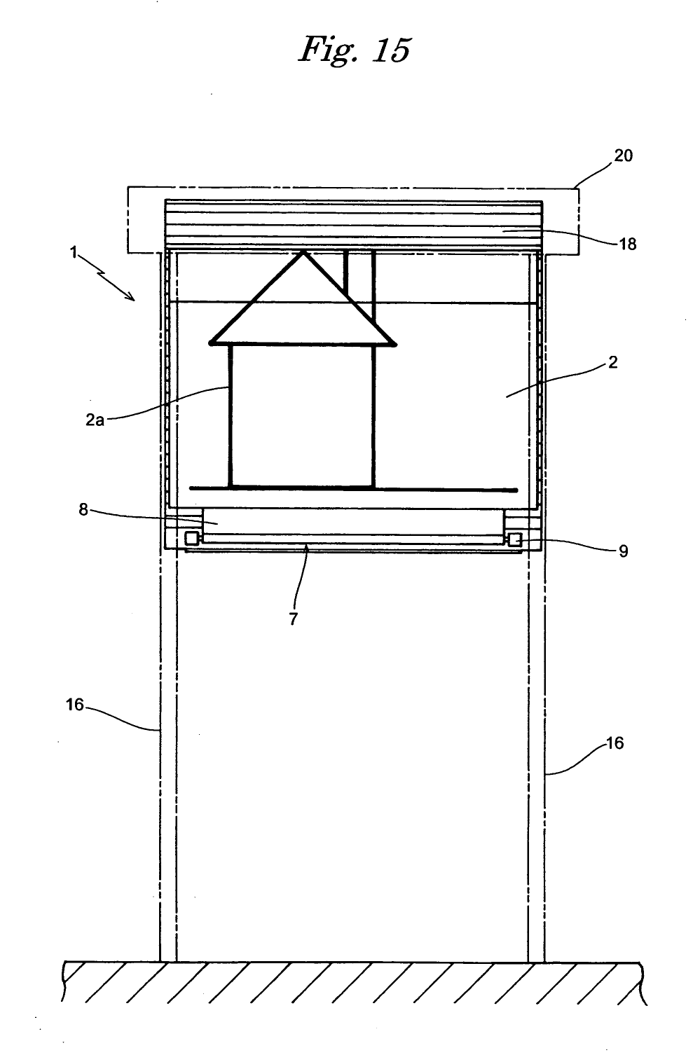

FIGS. 13 to 15 show a third embodiment of the display device 1 for a shutter according to the invention. In this embodiment, the shutter 18 is called outward rolling type having a rolling/unrolling roller 19, which rolls and unrolls the shutter 18 in directions opposite to those in the case of the previous first embodiment. The display device 1 for a shutter is slightly different in the method of installation from and the same in construction as the first embodiment. The shutter 18 can be accommodated in a shutter box 20 formed on its upper surface part. With this outward rolling type shutter 18, the display sheet 2 is rolled while it is located on the inner periphery of the roll of the shutter 18. This means that the rolling diameter is less than the case of the sole shutter 18 to an extent corresponding to the thickness of the display sheet 2. The display sheet 2 is thus rolled at a speed lower than the rolling speed of the shutter 18. Thus, as shown in FIG. 15, as the shutter 18 is rolled on the rolling/unrolling roller 4, the display sheet 2 is shifted down relative to the shutter 18, and the pull sheet 8 is gradually rolled into the pulling unit 7. By setting such that the pull sheet 8 is substantially fully rolled it the pulling unit 7 in the fully raised state of the shutter 18, as shown in FIG. 13, the lower end of the display sheet 2 is at a position shifted up by about 15 cm from the pulling unit 7. As shown, this second embodiment and the above first embodiment are different in the rolling position of the pull sheet 8, but the position adjustment can be readily made on the site of installation.

In the case of FIG. 5, the vertical reinforcement members 10 are split by forming notches 21. The notches 21 serve such that when rolling and unrolling the shutter, they absorb vertical enlarging and contracting forces exerted to the reinforcement members 10, thus preventing deformation of the reinforcement members 10.

The display sheet 2 has the reinforcement members 10 applied to it for providing firmness. The rigidity of the reinforcement members 10, however, may become a cause of occurrence of a trouble that, when lowering the shutter 6, the lower ends of the vertical reinforcement members 10 are separated from the shutter 6 and fail to be guided up to the upper end of the shutter guide 16. It is one measure against this problem to remove some parts of the vertical reinforcement members 10 extending down to the lower end of the display sheet 2. As a more reliable measure, it is preferable to have the reinforcement members 10 which are non-magnetic members to be in close contact with the shutter by providing a strip-like magnet sheet as noted above along the lower end of the surface of the display sheet 2. For the reinforcement members 10 to be able to readily slide over the surface of the shutter 6, the low friction means provides an effective function.

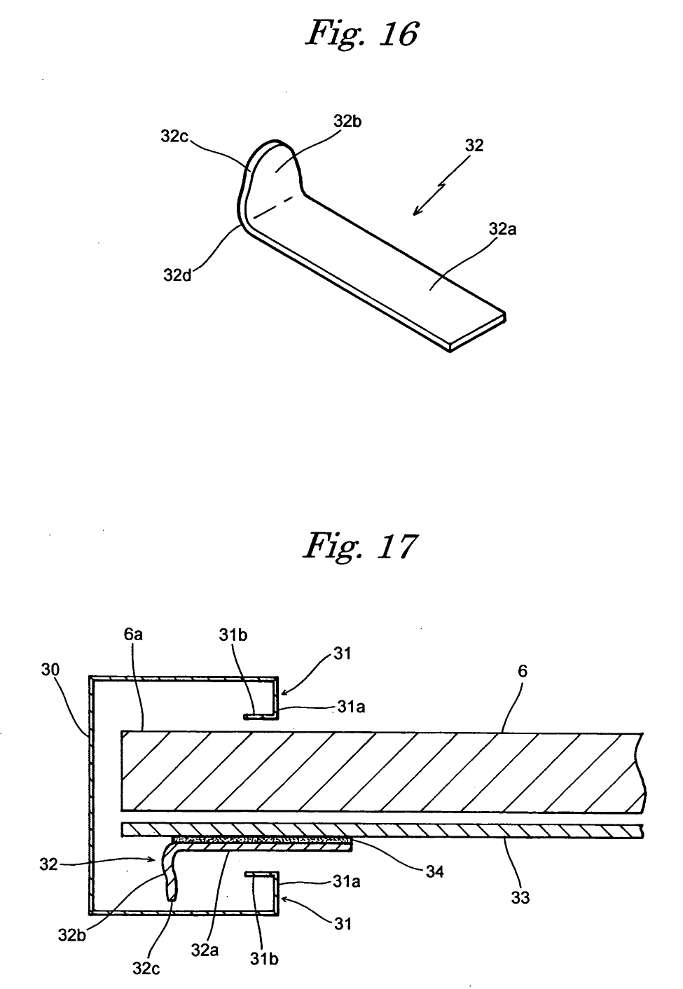

A fourth embodiment of the invention will now be described with reference to FIGS. 16 to 19.

In the Figures, reference numeral 30 designates a shutter guide for accommodating and guiding each edge 6a of the shutter 6.

Reference numeral 31 designates engagement parts provided on the shutter guide 30. The engagement parts are formed as a pair on the opposite sides of a slot, in which each edge 6a of the shutter 6 is accommodated. Each engagement part has a perpendicular part 31a extending toward the shutter 6 accommodated and a contact part 31b extending from the free end of the perpendicular part 31a and parallel to the shutter 6. Reference numeral 32 designates a stopper provided over the surface of the shutter 6 and bonded by a double-side bond tape or like bonding material to a sheet member 33 as display member. As shown in FIG. 16, the stopper 32 has a flat part 32a and a bent extension 32b extending as a bent end part from the flat part 32a.

The flat part 32a of the stopper 32 is bonded by adhesive or the like to the sheet member 33. The bent extension 32b extends away from the sheet member 33 in the shutter guide 30, and has a length, which is set such that the free end part of the bent extension 32b can engage with the contact part 31b in the associated engagement part 31 of the shutter guide 30 when the sheet member 33 is displaced away from the shutter guide.

The end part 32c of the bent extension 32b of the stopper 32 is tapered or substantially arch like. Thus, when the sheet member 33 is moved vertically, the stopper 32 can bent smoothly moved along the shutter guide by readily clearing a protuberance or an interfering part that may be encountered.

In practice, a plurality of stoppers 32 is mounted at intervals to each edge part of the sheet member 33. In mounting the stoppers 32 on the sheet member 33, first the sheet member 33 is disposed on the shutter 6, and then the stoppers 32 are mounted on the sheet member 33. As shown in FIG. 19, the bent extension 32b of the stopper 32 is inserted into the shutter guide 30, and then the stopper 32 is inserted into the depth of the shutter guide 30 by turning it in the direction of arrow in FIG. 19 to be secured at an appropriate position by double-side adhesive tape 34 to the sheet member 33. The stopper 32 has a round outer part at the boundary between the flat part 32a and bent extension 32b. The stopper 32 thus can be smoothly turned and disposed even with a slight space between the sheet member 33 and the associated engagement part 31 of the shutter guide 30.

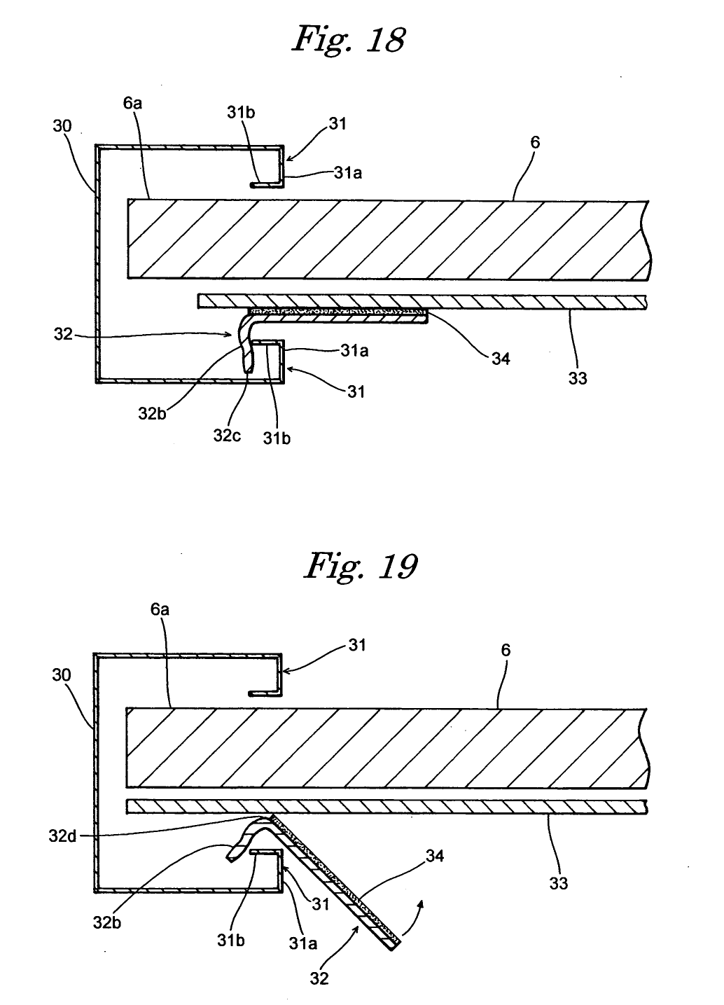

It will be appreciated that in this embodiment, when the sheet member is caused by a sudden wind or the like to be rocked or moved so that it is going to get out of a slot of the shutter guide 30, as shown in FIG. 18, the bent extension 32b of each stopper 32 mounted in each edge part of the sheet member 33 is brought into engagement with the associated engagement part 31 formed on each side of each slot of the shutter guide 30, i.e., in this embodiment the contact part 31b extending from the perpendicular part 31a, and its detachment is perfectly prevented. The sheet member 33 as the display surface thus can be held in good order at all times and provide sufficient effect of display.

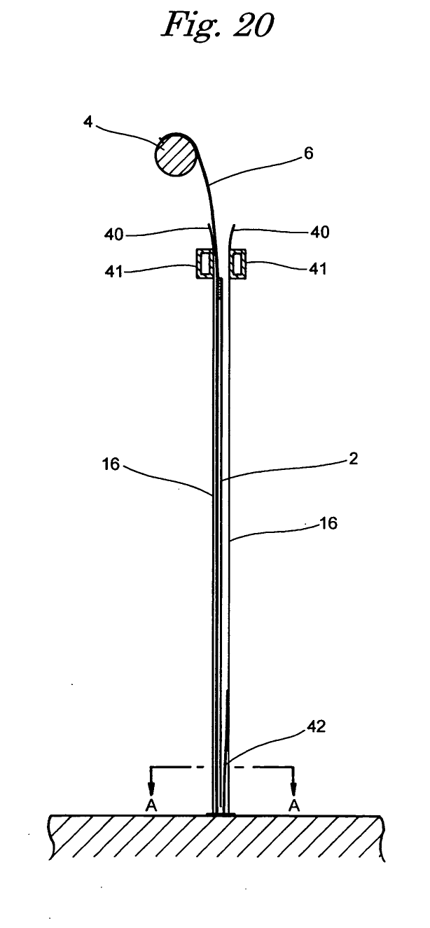

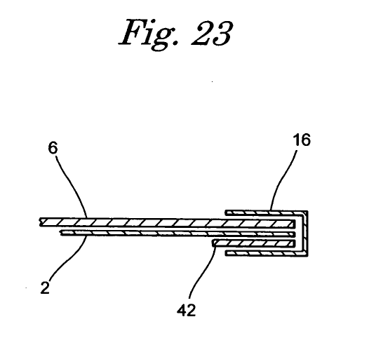

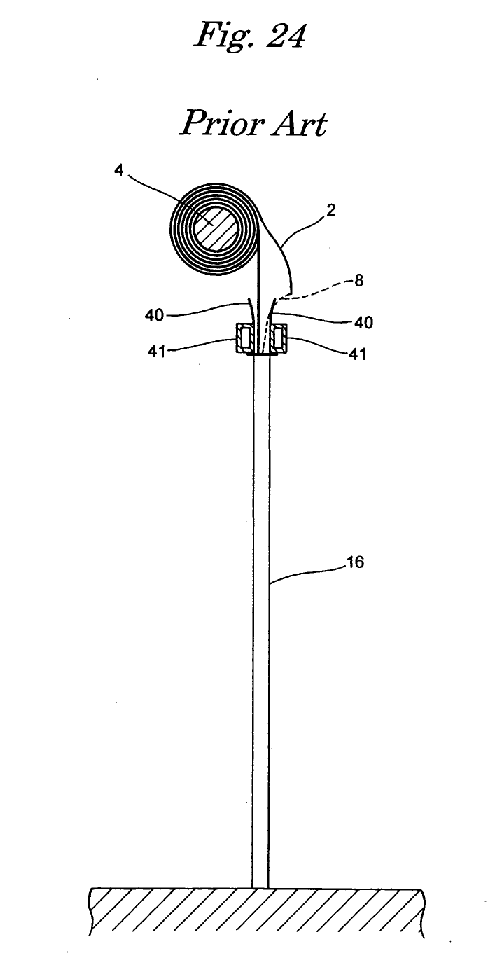

FIGS. 20 to 23 show a fifth embodiment of the display device for a shutter according to the invention. FIG. 24 shows a problem to be improved, which is inherent in the display device for a shutter. Referring to FIG. 24, a guide 40 which is mainly installed on a manual drive type shutter, is provided a shutter frame upper part horizontal member 41 on the extension of the shutter guide. The guide 40 has a V figure shape extending on the opposite sides of the shutter 6. The guide 40 serves to guide the shutter 6 for smooth vertical movement between the rolling/unrolling roller 4 and the shutter guide 16.

In the display device for a shutter according to the invention, however, as shown in FIG. 24, when the display sheet 2 having been rolled together with the shutter 6 on the rolling/unrolling roller 4 is unrolled, it is possible that its lower end clears the guide 40 and is detached. (The pull sheet 8 which is tied to a central part of the display sheet 2 other than the opposite edges, is not restricted by the guide 40.)

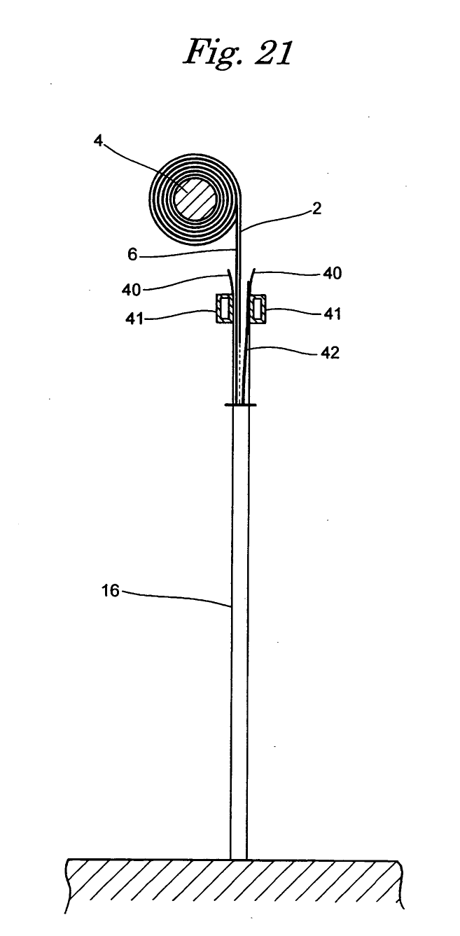

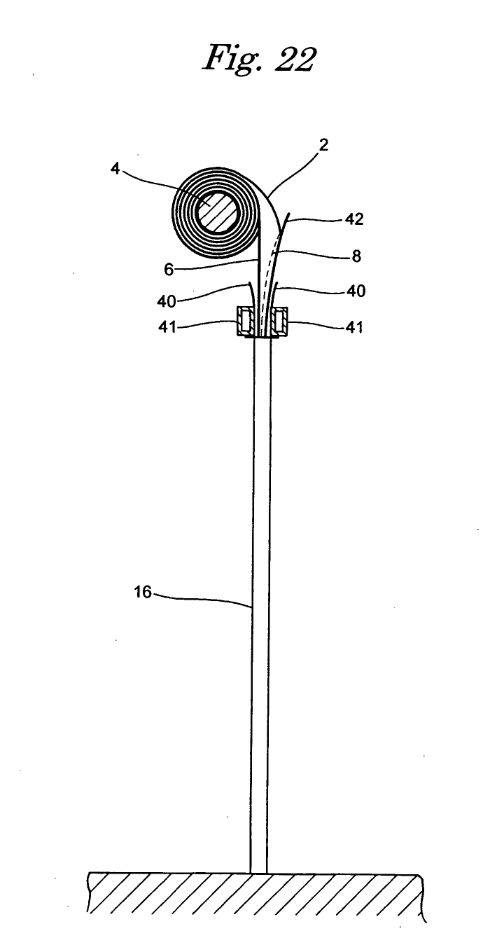

In this embodiment, flexible strip-like guide members 42 are provided, which each have the stem secured to the lower end part (water cut-off part) of the opposite edges of the shutter 6 on the side of the display sheet 2. The guide members 42 always intervene between the lower end part of the surface of the display sheet 2 and the shutter guide 16 for vertical movement therealong. In the lowered state of the shutter 6 shown in FIG. 20, the guide members 41 are located between the lower end part of the surface of the display sheet 2 and the shutter guide 16, and when viewed from the front they are substantially concealed by the shutter guide 16 and not notable. As shown in FIG. 21, as the shutter 6 is raised, the upper part of each guide member 42 enters the shutter frame. In the fully raised state of the shutter 6, as shown in FIG. 22, the guide members 42 are located such as to cover the existing guide 40 and face the surface of the lower end part of the display sheet 2. Thus, the display sheet 2 can be reliably accommodated in and guided along the guide 40 for smooth unrolling without possibility of its lower end part by clearing the guide 40.

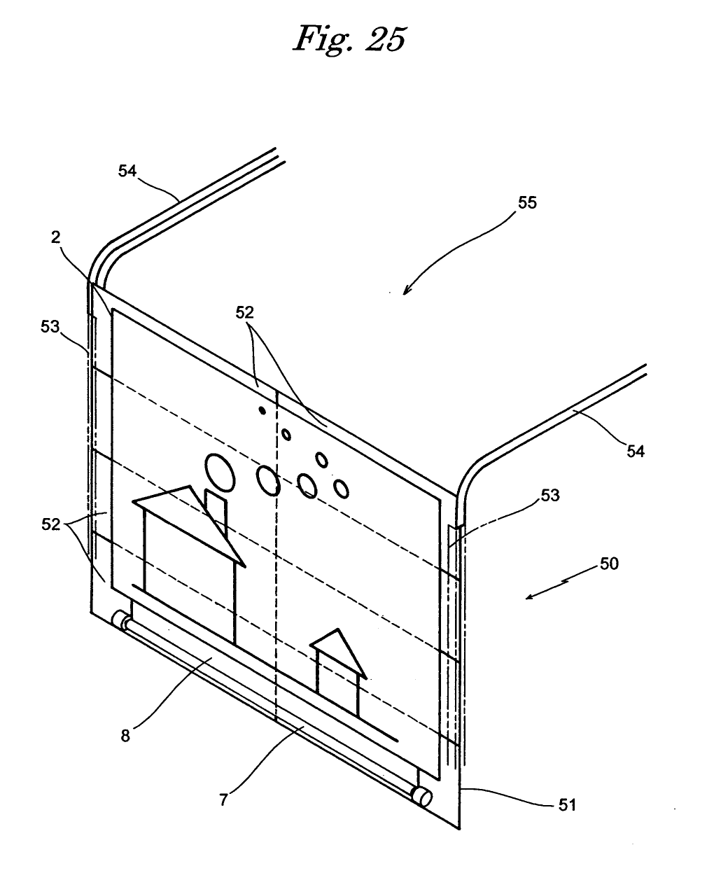

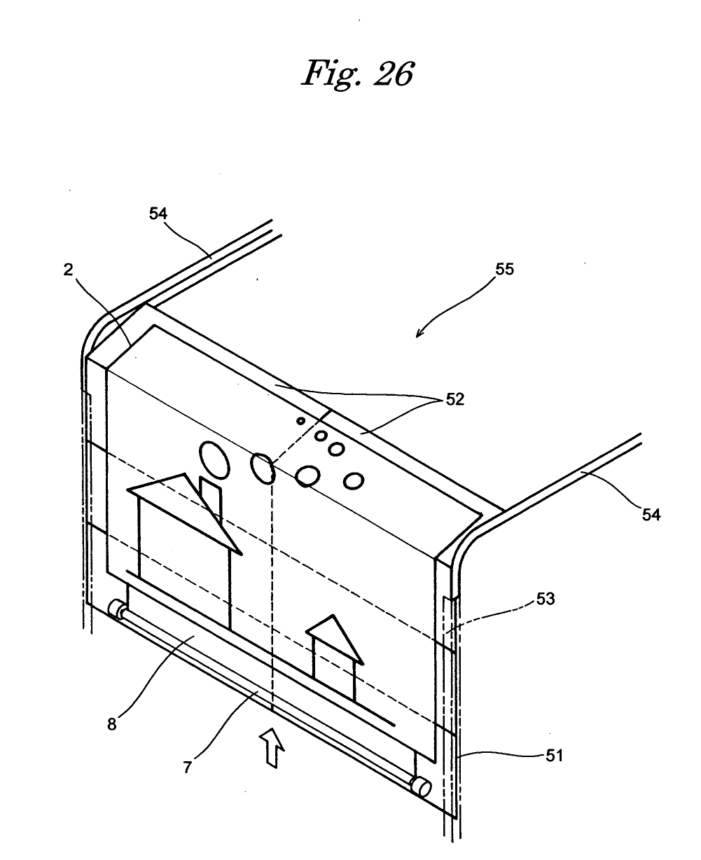

FIGS. 25 and 26 show a sixth embodiment of the display device for a shutter according to the invention. The display device 50 for a shutter is shown in the state that it is installed on a garage door 51 for opening and closing a garage opening instead of the above rolling shutter. The garage door 51 is constituted by combining eight, i.e., two in each low and four in each column, rectangular door sections 52. When the garage door 51 is in the lowered, i.e., closed, state, its opposite edges are guided along vertical tracks 53 in its movement into an accommodating part 55 on the ceiling surface. When the garage door is open, its opposite edges are guided by horizontal tracks 54.

A pulling unit 7 which pulls a rolled pull sheet 8 tied to the lower end of the display sheet 2, is secured to the lower end of the surface of the garage door 51. The display sheet 2 has its upper end secured by double-side bond or adhesive tape to an upper part of the garage door 51 (in the closed state thereof) and its lower end pulled downward by the pulling unit 7, so that it is attached to the entire surface of the garage door 51.

When the garage door 51 being raised or lowered passes by the boundary between the vertical and horizontal tracks 53 and 54, as shown in FIG. 26, the door sections 52 undergo orientation change from vertical to horizontal or from horizontal to vertical. Thus, the door sections 52 are bent at their upper and lower tied parts. For this reason, the vertically adjacent door sections are hinged to each other, so that they can be freely bent. When the door sections 52 are bent, the lower part of the bent part of the display sheet 2 attached to the surface of the door sections 52 are pulled upward. However, the display sheet 2 can be moved upward by unrolling the pull sheet 8 rolled in the pulling unit 7. Thus, when the garage door 51 is being moved vertically as well as in its raised or lowered state, the display sheet 2 can be reliably held attached without warping to the surface of the garage door 51.

As has been described in the foregoing, with the display device for a shutter according to the invention it is possible to provide an existing shutter with various advertisement and decoration effects excellent in the display character without need of conventional elaborate installation work but with a very simple work.

The pulling member for having the sheet member in close contact with the shutter surface, has one part mounted on the shutter and another part coupled to the lower end part of the sheet member to bias the sheet member for pulling the sheet member downward. Alternatively, the pulling member for having the sheet member in close contact with the shutter surface, is mounted on the shutter and has a rotor connected to the lower end part of the sheet member and capable of rolling the same part to bias the sheet member or pulling the sheet member downward. As a further alternative, the pulling member for having the sheet member in close contact with the shutter surface, is constituted by a weight member mounted on the lower end part of the sheet member. Thus, when the shutter is raised and lowered, the sheet member can be held stretched in good order without being distorted or tilted, and it can be satisfactorily held in close contact with the shutter surface.

Also, by forming a display subject for the advertisement or decoration purpose on the sheet member, when the shutter is lowered, can be provided as suitable advertisement or decoration readily notable by passersby.

Furthermore, by providing the sheet member surface with an anti-contamination process such as film application or coating permitting erasing graffiti, any contamination damage such as graffiti to the shutter can be coped with by readily erasing it with a solvent. It is thus possible to hold good aesthetic sense.

Still further, the sheet member is provided with a flexible magnet sheet, and the magnet sheet has its surface provided with a low friction means such as applying floropolymer sheet or coating floropolymer so that it can slide over the shutter while being magnetically attached to the same. Thus, it is possible to prevent such status that the sheet member is wrinkled or turned upward from the end, and it is possible to roll the sheet member together with the shutter in good order.

Further, the sheet member has the opposite vertical edge disposed in the shutter guide for guiding the opposite vertical edge of the shutter. Thus, the sheet member can be prevented from being flapped and trailing, and can be positioned in good order on the shutter.

Yet further, the pulling member has a magnet member permitting detachable mounting on the shutter. The magnet member permits mounting of the display device for a shutter without causing damage to the existing shutter such as forming a hole thereon, and it can be detachable for position adjustment of the display sheet.

Further, the sheet member has a flexible sheet-like reinforcement member applied to it, thus providing for firmness to the thin sheet member, which is not firm in itself, thus permitting the sheet member to be stretched and rolled in a state free from wrinkling or twisting.

Further, the sheet member is provided with vertical reinforcement members, which are provided with notches for buffering vertical shocks applied to the sheet member when vertically moving the shutter. Thus, when raising and lowering the shutter, the notches can absorb the elongating or contracting forces exerted to the vertical reinforcement members to prevent deformation of the reinforcement member.

Further, the sheet member is provided with a reinforcement member applied to its lower end, and the opposite ends of the reinforcement member are disposed in the shutter guide for guiding the opposite vertical edges of the shutter. Thus, the shutter can be raised and lowered while being guided along the shutter guide without trouble at all times with the lower end of the sheet member guided along the shutter side.

Further, the magnet member for holding the reinforcement member applied to the lower end of the shutter in close contact with the shutter, is provided on the sheet member at a position thereof corresponding to other reinforcement member. It is thus possible to prevent the trouble that the lower end of the reinforcement member is spaced apart from the shutter surface and not guided along the shutter guide.

Further, the rotor capable of rolling the lower part of the sheet member to bias the same for pulling the sheet member downward, is accommodated together with the sheet member coupling part in the box member mounted on the shutter, and for preventing intrusion of rainwater into the box member through an opening thereof, through which the sheet member passes, the sheet member is provided with rainwater intrusion preventing member having the free end in contact with the sheet member surface at all times. Thus it is possible to prevent intrusion of rainwater or the like into the box member accommodating the rotor and the pull sheet and hold the aesthetic sense without contamination or other damage.

Further, the shutter guide accommodating the opposite vertical edges of the shutter has engagement parts formed as pairs on the opposite sides of the slots extending along the opposite vertical edges of the shutter, each engagement part extending toward the shutter edge accommodated in each slot, and the shutter member located over the shutter surface has stoppers provided on the surface of the vertical edges, each stopper having a bent extension extending away from the sheet member in the shutter side. Thus, when the sheet member is caused by wind or the like to be rocked or moved and is going to get out of the slots of the shutter guides, the stoppers on the sheet member are brought into engagement with the engagement parts of the shutter guide, thus preventing the detachment of the sheet member from the shutter guide.

Further, the guide for guiding the shutter is disposed in front of the shutter accommodating part on the extension of the shutter guide, and for preventing the lower end of the sheet from clearing and being detached from the guide when the sheet member is rolled, the guide member is provided on the lower end part of each vertical edge of the shutter to intervene between the lower end part of the sheet member and the shutter guide and be vertically moved along the shutter guide. Thus, the sheet member can be reliably guided without possibility of clearing and being detached from the existing guide for guiding the shutter for vertical movement, and the sheet member can be smoothly rolled and unrolled.

What is claimed is:

1. A display device for a shutter comprising:
a sheet member located on the surface of a vertically movable shutter in the closed state thereof to close an opening and, when the shutter is raised, accommodated together with the shutter in a shutter accommodating part provided above the opening, the sheet member having an upper end part secured to an upper end part of the shutter; and
a pulling member for biasing the lower end part of the sheet member to pull the same downward so that the sheet member can be stretched without warping over the surface of the shutter in the lowered state thereof and, when raising the shutter, can be rolled in good order together with the shutter while being located on the shutter surface, thereby holding the sheet member in close contact with the shutter surface.

2. The display device for a shutter according to claim 1, wherein the pulling member for having the sheet member in close contact with the shutter surface has one part mounted on the shutter and another part coupled to the lower end part of the sheet member to bias the sheet member for pulling the same downward.

3. The display device for a shutter according to claim 1, wherein the pulling member for having the sheet member in close contact with the shutter surface is mounted on the shutter and includes a rotor, which is coupled to a lower part of the sheet member, and is capable of rolling a lower part of the sheet member to bias the sheet member for pulling the sheet member downward.

4. The display device for a shutter according to claim 1, wherein the pulling member for having the sheet member in close contact with the shutter surface is a weight member mounted on a lower end part of the shutter.

5. The display device for a shutter according to claim 1, wherein the sheet member has a display subject formed thereon for the advertisement or decoration purpose.

6. The display device according to claim 1, wherein the sheet member has its surface provided with anti-contamination process of film application or coating permitting removal of graffiti or the like.

7. The display device for a shutter according to claim 1, wherein the sheet member is provided with a flexible magnet sheet, the magnet sheet having the surface provided with a low friction means of applying a fluoropolymer sheet or coating fluoropolymer so that it can slide over the shutter while being magnetically attached to the same.

8. The display device for a shutter according to claim 1, wherein the sheet member has its opposite vertical edges disposed in a shutter guide for guiding the opposite vertical edges of the shutter.

9. The display device for a shutter according to claim 1, wherein the pulling member is provided with a magnet member for permitting detachable mounting on the shutter.

10. The display device according to claim 1, wherein the sheet member has a flexible sheet-like reinforcement member applied to it.

11. The display device for a shutter according to claim 1, wherein the sheet member is provided with vertical reinforcement members applied to it, the vertical reinforcement members having notches to buffer vertical shocks exerted to the sheet member when the shutter is moved vertically.

12. The display device for a shutter according to claim 1, wherein the sheet member is provided with a reinforcement member applied to its lower end, the reinforcement member having the opposite edges disposed in a shutter guide for guiding the opposite vertical edges of the shutter.

13. The display device for a shutter according to claim 12, wherein a magnet member is provided on the sheet member at a position thereof corresponding to a reinforcement member applied to the lower end of the sheet member to have the reinforcement be in close contact with the shutter.

14. The display device for a shutter according to claim 3, wherein the rotor which is coupled to a lower part of the sheet member and is capable of rolling a lower part of the sheet member to bias the sheet member for pulling the sheet member downward, is accommodated together with a sheet member coupling part in the box member mounted on the shutter, and the box member has a projecting rainwater intrusion prevention member having a free end in contact with the surface of the sheet member at all times to prevent intrusion of rainwater through a box member opening with the sheet member inserted therethrough.

15. The display device for a shutter according to claim 8, wherein the shutter guide accommodating the opposite vertical edges of the shutter has engagement parts formed as pairs on the opposite sides of the slots extending along the opposite vertical edges of the shutter, each engagement part extending toward the shutter edge accommodated in each slot, and the sheet member located over the shutter surface has stoppers provided on the surface of the vertical edges, each stopper having a bent extension extending away from the sheet member in the shutter guide, the stoppers on the sheet member being brought into engagement with the engagement parts of the shutter guide when the sheet member is caused by wind or the like to be rocked or moved and is going to get out of the slots of the shutter guides, thereby preventing the detachment of the sheet member from the shutter guide.

16. The display device for a shutter according to claim 15, wherein the stoppers each have a flat part and a bent extension extending from one end of the flat member and capable of being brought into engagement with the associated engagement part of the shutter guide, the flat part being secured by double-side bond tape or like bond to the surface of each vertical edge of the sheet member.

17. The display device for a shutter according to claim 15, wherein the bent extension of each stopper has a tapered end part so that it can be smoothly moved along the shutter side by clearing a protuberance or an interfering object, if any, present in the shutter guide.

18. The display device for a shutter according to claim 15, wherein each stopper has a round outer part corresponding to the juncture between the flat part and the bent extension.

19. The display device for a shutter according to claim 15, wherein a plurality of stoppers are mounted at interval on the vertical edges of the sheet member.

20. The display device for a shutter according to claim 15, wherein each engagement part of the shutter guide has a perpendicular part extending toward the shutter and a contact part extending from the free end of the perpendicular part and parallel to the shutter and capable of being brought into engagement with the associated stopper of the shutter guide.

21. A display device for a shutter comprising:
a sheet member located on the structure of a vertically movable shutter in the closed state thereof to close an opening and, when the shutter is raised, is accommodated together with the shutter in a shutter accommodating part provided above the opening, the sheet member having an upper end part secured to an upper end part of the shutter; and
a pulling member for biasing the lower end part of the sheet member to pull the same downward so that the sheet member can be detached without warping over the surface of the shutter in the lowered state thereof and, when raising the shutter, can be rolled in good order together with the shutter while being located on the shutter surface, thereby holding the sheet member in close contact with the shutter surface;
wherein:
a guide for guiding the shutter is disposed in front of the shutter accommodating part on the extension for the shutter guide; and
for preventing the lower end of the sheet member from clearing and being detached from the guide when the sheet member is unrolled, a guide member is provided on the lower end part of each vertical edge of the shutter on the side of the sheet member such as to intervene between the lower end part of the sheet member surface and the shutter guide and be vertically movable along the shutter guide.

22. The display device for a shutter according to claim 1, wherein the shutter is wound on a rolling/unrolling roller for rolling and unrolling.

23. The display device for a shutter according to claim 1, wherein the shutter is accommodated in a shutter accommodating part formed on an upper part of the shutter body and is capable of being lowered from the shutter accommodating part when lowering the shutter for closing the opening.
